(19) United States
(12) Patent Application Publication
(10) Pub. No.: US 2010/0128555 A1
(43) Pub. Date: May 27, 2010

(54) SYSTEMS AND METHODS FOR MATERIAL BLENDING AND DISTRIBUTION

(75) Inventor: John E.Q. Hughes, Phoenix, AZ (US)

Correspondence Address: INTELLECTUAL PROPERTY / TECHNOLOGY LAW, PO BOX 14329, RESEARCH TRIANGLE PARK, NC, 27709, US

(73) Assignee: ADVANCED TECHNOLOGY MATERIALS, INC., Danbury, CT (US)

(21) Appl. No.: 12/599,291

(22) PCT Filed: May 9, 2008
(86) PCT No.: PCT/US08/63276

§ 371 Date: Nov. 24, 2009

Related U.S. Application Data
(60) Provisional application No. 60/916,966, filed on May 9, 2007.

(51) Int. Cl. B01F 15/02; B01F 15/04

(52) U.S. Cl. 366/132; 366/134

(57) ABSTRACT

Systems and methods for mixing pure feed materials utilizes a first and a second compressible volume, such as defined in first and second liner-based containers adapted for pressure dispensation, wherein such materials are supplied to a mixing apparatus (e.g., reversible-flow or circulatable flow apparatus) adapted to form and maintain a mixture or suspension. Multiple redundant groups of containers may be used to enable mixing of contents of one group while contents of another group are being dispensed, to provide uninterrupted delivery of feed material to a process. Sensors adapted to generate signals indicative of flow, weight/mass, particle size distribution, concentration, and other material properties may be provided.

### CROSS-REFERENCE TO RELATED APPLICATION

This application claims priority to U.S. Provisional Patent Application No. 60/916,966 filed on May 9, 2007. The entire disclosure of such application is hereby incorporated by reference herein.

### BACKGROUND OF THE INVENTION

1. Field of the Invention

The present invention relates to the blending and distribution of ultra pure materials (e.g., feedstock materials including any of solids, liquids, mixtures, slurries, colloidal suspensions, aqueous solutions containing dissolved gases or solids, and solutions), maintenance of resulting products in blended form, and distribution of ultra pure blended products to points of demand or use.

2. Description of the Related Art

Material blending and distribution of mixtures or solutions to process equipment (e.g., process tools) is routinely performed in a variety of manufacturing processes. Numerous industries require that feed materials be provided in ultra pure form to ensure purity. The term “feed material” in this context refers broadly to any of various materials used or consumed in manufacturing and/or industrial processes. In the context of manufacturing microelectronic devices, the presence of even small amounts of certain contaminants can render a resulting product deficient or even useless for its intended purpose. The containers used to supply feed materials to the process systems manufacturing such products therefore must be of a character that avoids contamination issues in the process. Specifically, the container must be rigorously clean in condition. The container also must avoid “particle shedding,” outgassing, and any other forms of contaminant contribution to the feed material being stored in the container from the container's material-contacting components. The container further must maintain the material prior to its use in a pure state, without degradation or decomposition of the contained material, given that exposure of feed materials to ultraviolet light, heat, environmental gases, debris, and impurities may impact such materials adversely.

In the manufacture of semiconductor devices, Chemical Mechanical Planarization or Polishing (CMP) is routinely performed to smooth and/or polish wafers and other semiconductor products by both mechanical (abrasion) and chemical means. In a typical CMP process, various feedstock materials are blended to form a CMP suspension that is delivered to a planarization machine for application to a work surface. One feed material for a CMP material may include a silica-based slurry, and another feed material may include a chemical additive, reactant, or oxidizer (e.g., hydrogen peroxide). Various particulate materials and carriers may be used, and in various proportions according to the desired end use application. One problem with CMP suspensions, however, is that the particulate material often will not remain suspended for a prolonged period of time. Some form of agitation, stirring, or mixing—for example, in a holding tank—is typically employed just prior to use to ensure that the particulate remains in suspension. The suspension (e.g., based on particle distribution and solids percent) can be maintained by keeping the fluid in constant motion; however, care must be given to avoid subjecting the entrained particles to excessive shear, which can lead to undesirable agglomeration.

Keeping a CMP suspension in constant motion can be challenging with conventional equipment. CMP suspensions are both abrasive and reactive, such that pumps or agitators dedicated to moving such fluids are subject to excessive wear, leading to substantially reduced efficiency or even premature failure. It would be desirable to mitigate these problems in the supply of a CMP suspension.

Given the variety of CMP chemistries that may be used, it would be desirable to provide separately packaged CMP feed materials that may be blended at the point of use to yield the desired suspension, so as to provide maximum flexibility to the user. It would be further desirable to maintain such feed materials in substantially pure form up to the point of use, while minimizing the need for container cleaning and/or disposal. Accomplishing both of these goals simultaneously with conventional containers, however, may lead to the generation of excessive waste with concomitantly increased cost.

Thus, there is a need in the art for systems that permit ultra pure materials—including reactive and/or abrasive materials—to be blended, maintained in blended form, and delivered to a point of use (e.g., a process tools, such as a semiconductor process tool) in substantially pristine form, without deficiencies associated with prior fluid blending and distribution systems.

### SUMMARY OF THE INVENTION

The present invention relates in certain aspects to systems and methods for blending substantially pure feed materials, employing a first container defining a first compressible volume (e.g., a first collapsible liner disposed within a first housing), a second container defining a second compressible volume (e.g., a second collapsible liner disposed within a second housing), and a mixing apparatus adapted to mix at least a portion of a first feed material from the first container with at least a portion of a second feed material from the second container. The mixing apparatus is preferably adapted to further maintain the mixture after a substantially uniform blend is attained. A dispensing port permits the resulting mixture to be dispensed to a desired point of use, such as a process tool, storage receptacle, or other system.

In one aspect, the invention relates to a system for blending feed materials, comprising:
a first container defining a first compressible volume and adapted for selective discharge of a first feed material from the first compressible volume;
a second container defining a second compressible volume and adapted for selective discharge of a second feed material from the second compressible volume;
a mixing apparatus in at least intermittent fluid communication with the first compressible volume and the second compressible volume, said mixing apparatus being adapted to mix at least a portion of a first feed material from the first container with at least a portion of a second feed material from the second container to form a mixture; and
a dispensing port adapted to dispense the mixture to a desired point of use.

In another aspect, the invention relates to a system for blending or agitating feed materials, comprising:
a first container defining a first compressible volume and adapted for selective discharge of a first feed material from the first compressible volume;
a second container defining a second compressible volume, the second container being adapted for selective receipt of at least a portion of the first feed material, and for selective subsequent discharge of said at least a portion of the first feed material;
a flow directing element adapted to selectively direct at least a portion of the first feed material through a fluid flow path including the first container and the second container to agitate said first feed material; and
a dispensing port adapted to dispense the agitated first feed material to a desired point of use.

In a further aspect, the invention relates to a system for supplying blended feed material, the system comprising:
a first plurality of containers, with each container of the first plurality of containers including a compressible volume adapted for selective discharge of at least one feed material;
a second plurality of containers, with each container of the second plurality of containers including a compressible volume adapted for selective discharge of at least one feed material;
at least one mixing apparatus in selective fluid communication with at least one of the first plurality of containers and the second plurality of containers, said at least one mixing apparatus being adapted to blend or mix feed material supplied by at least one container of the first plurality of containers, and being adapted to blend or mix feed material supplied by at least one container of the second plurality of containers; and
a dispensing port adapted to dispense said at least one feed material blended or mixed by the at least one mixing apparatus to a desired point of use

In a further aspect, the invention relates to a system for blending feed materials, comprising:
a first container adapted for pressurized or pressure-assisted discharge of a first feed material, the first container comprising (i) a first collapsible liner comprising a flexible film material and defining a first port, (ii) a first housing adapted to contain the first collapsible liner, said housing defining at least a first orifice adapted to communicate with the first port, wherein the first housing and the first liner define a sealable first volume therebetween, and wherein the first housing is more rigid than the first liner; and (iii) a first gas feed passage coupleable to at least one pressure source adapted to pressurize the first volume during discharge operation;
a second container adapted for pressurized or pressure-assisted discharge of a second feed material, the second container comprising (i) a second collapsible liner comprising a flexible film material and defining a second port, (ii) a second housing adapted to contain the second collapsible liner, said housing defining at least a second orifice adapted to communicate with the second port, wherein the second housing and the second liner define a sealable second volume therebetween, and wherein the second housing is more rigid than the second liner; and (iii) a second gas feed passage coupleable to said at least one pressure source to pressurize the second volume during discharge operation;
a mixing apparatus in at least intermittent fluid communication with the first collapsible liner and the second collapsible liner, said mixing apparatus being adapted to mix at least a portion of a first feed material from the first container with at least a portion of a second feed material from the second container to form a mixture; and
a dispensing port adapted to dispense the mixture to a desired point of use

In another aspect, the invention relates to a method for blending feed materials utilizing (A) a first container defining a first compressible volume and adapted for selective discharge of a first feed material from the first compressible volume, (B) a second container defining a second compressible volume and adapted for selective discharge of a second feed material from the second compressible volume, (C) and a mixing apparatus in at least intermittent fluid communication with the first compressible volume and the second compressible volume, the method comprising:
establishing any of mass, weight, density, specific gravity, and volume of a first material supplied or to be supplied to the first compressible volume;
establishing any of mass, weight, density, specific gravity, and volume of a second material supplied or to be supplied to the second compressible volume;
compressing the first compressible volume to discharge at least a portion of the first material into the mixing apparatus;
compressing the second compressible volume to discharge at least a portion of the second material into the mixing apparatus;
flowing at least a portion of the first material and at least a portion of the second material through the mixing apparatus to form a mixture; and
dispensing at least a portion of the mixture to a desired point of use.

A further aspect of the invention relates to a method for blending feed materials utilizing (A) a first container defining a first compressible volume and adapted for selective discharge of at least a first feed material from the first compressible volume, and (B) a second container defining a second compressible volume and adapted for selective discharge of at least a first feed material from the second compressible volume, the method comprising:
supplying said at least a first feed material from any of the first compressible volume and the second compressible volume to a mixing apparatus disposed in at least intermittent fluid communication with the first compressible volume and the second compressible volume; and
flowing said at least a portion of the at least a first feed material through the mixing apparatus to yield a blended feed material or mixture.

A further aspect of the invention relates to method for supplying blended feed material utilizing a first plurality of containers and a second plurality of containers, with each container including a compressible volume adapted for selective discharge of at least one feed material, the method comprising:
blending at least one feed material obtained from the first plurality of containers utilizing at least one mixing apparatus in selective fluid communication with the first plurality of containers;
blending at least one feed material obtained from the second plurality of containers utilizing at least one mixing apparatus in selective fluid communication with the second plurality of containers;
dispensing blended feed material from the first plurality of containers to a desired point of use; and
dispensing blended feed material from the second plurality of containers to a desired point of use.

A further aspect of the invention relates to a method for supplying blended feed material comprising a first feed material and a second feed material that is compositionally different from the first feed material, the method comprising:
supplying said second feed material to a first collapsible liner of a first container initially containing said first feed material, said first container comprising (i) said first collapsible liner comprising a flexible film material and defining a first port, (ii) a first housing adapted to contain the first collapsible liner, said housing defining at least a first orifice adapted to communicate with the first port, wherein the first housing and the first collapsible liner define a sealable first volume therebetween, and wherein the first housing is more rigid than the first liner; and (iii) a first gas feed passage coupleable to said at least one pressure source adapted to selectively pressurize the first volume; and
pressurizing said first volume to promote discharge at least a portion of the first material and at least a portion of the second material from the first liner and to promote mixing between the discharged first material and the discharged second material.

A further aspect of the invention relates to feed material supply system comprising:
a first container adapted for pressurized or pressure-assisted discharge of a first feed material, the first container comprising (i) a collapsible liner comprising a flexible film material, defining a port, and initially containing said first feed material, (ii) a housing adapted to contain the collapsible liner, said housing defining at least one orifice adapted to communicate with the port, wherein the housing and the liner define a sealable first volume therebetween, and wherein the housing is more rigid than the liner; and (iii) a gas feed passage coupleable to at least one pressure source adapted to selectively pressurize the first volume;
a feed material supply apparatus operatively coupled to supply a second feed material to contact said first feed material in the collapsible liner, wherein the second feed material is compositionally different from the first feed material; and
at least one metering apparatus or sensor adapted to generate an output signal correlative of an amount of second feed material supplied by the feed material supply apparatus to contact said first feed material in the collapsible liner;
wherein said first container is operatively coupled to supply said first feed material and said second feed material to a downstream process tool.

In another aspect of the invention, any of the foregoing aspects may be combined for additional advantage.

Other aspects, features and advantages of the invention will be more fully apparent from the ensuing disclosure and appended claims.

### BRIEF DESCRIPTION OF THE DRAWINGS

FIG. 1 is a schematic interconnect diagram of a first system utilizing liner-based containers for blending feed materials along a reversible mixing flow path that includes the first container and the second container, according to a first embodiment of the present invention.

FIG. 2 is a photograph of a portion of one implementation of a portion of the system of FIG. 1.

FIG. 3 is a schematic interconnect diagram of a second system for blending feed materials along a flow path that does not include the first container and the second container, according to another embodiment of the present invention.

FIG. 4 is a schematic interconnect diagram of a first mixing apparatus portion of the system of FIG. 3, according to yet another embodiment of the present invention.

FIG. 5 is a schematic interconnect diagram of a second mixing apparatus portion of the system of FIG. 3, according to another embodiment of the present invention.

### DETAILED DESCRIPTION OF THE INVENTION

The disclosures of the following patents are hereby incorporated herein by reference in their respective entireties: U.S. Pat. No. 7,188,644 entitled “APPARATUS AND METHOD FOR MINIMIZING THE GENERATION OF PARTICLES IN ULTRAPURE LIQUIDS;” and U.S. Pat. No. 6,698,619 entitled “RETURNABLE AND REUSABLE, BAG-IN-DRUM FLUID STORAGE AND DISPENSING CONTAINER SYSTEM.”

The present invention relates in one aspect to systems for blending substantially pure feed materials dispensed from containers each including a compressible portion defining an internal volume, such as a collapsible liner disposed within a housing. A sealable volume between each liner and housing may be pressurized to discharge the contents of the liner from the container to a mixing apparatus or flow directing element(s) in at least intermittent fluid communication with each internal volume, and arranged to selectively control flow of such contents for agitation and/or mixing thereof. Discharge of the liner contents may be driven solely by such pressurization, or driven at least in part by other conventional means (e.g., gravity, centrifugal force, vacuum extraction, or other fluid motive means), and assisted with such pressurization.

The term “mixing apparatus” as described herein encompasses a wide variety of elements adapted to promote mixing between two or more materials. A mixing apparatus may include a region wherein two or more materials are combined. Static and/or dynamic mixing apparatuses may be used. Preferably, a mixing apparatus as described herein comprises a flow-through mixing apparatus through which two or more materials are flowed to effect desirable mixing or blending therebetween. In one embodiment, a mixing apparatus comprises a tee or similar branched fluid manifold wherein multiple flowable materials are brought together in two or more legs or conduits and the flowable materials in combination flow into a third leg or conduit. A mixing apparatus may include one or more elements (e.g., a venturi, orifice plate, or the like) adapted to cause contraction and expansion of fluid streams subject to flowing therethrough. A mixing apparatus may include one or more elements adapted to add or conduct energy (e.g., kinetic energy, magnetic energy, or the like, including but not limited to mechanical shaking or agitation, application of sonic energy or vibration, and the like) to material therein. In one embodiment, a mixing apparatus comprises a reversible-flow mixing apparatus adapted to permit two or more combined fluid streams to repeatedly traverse a flow path. Preferably, such a reversible-flow mixing apparatus includes fluid conduits and/or flow directing components operatively connected to one or more liner-based containers adapted for pressure dispensing, wherein a space between a collapsible liner and a substantially rigid container wall surrounding the liner may be selectively pressurized or de-pressurize to effectuate fluid flow. In another embodiment, a mixing apparatus comprises a circulatable-flow mixing apparatus adapted to permit two or more combined fluid streams to circulate within a flow path (e.g., without reversal). Preferably, such a circulatable-flow mixing apparatus includes a circulation loop with fluid conduits and/or flow directing components (e.g., valves) intermittently connected to one or more liner-based containers, such that material(s) from such container(s) may be dispensed into the mixing apparatus for mixing therein. At least one dispensing port is preferably provided in selective communication with the circulation loop.

A container as described herein preferably defines a compressible volume therein and is preferably adapted for selective material discharge therefrom. Such volume may be bounded or defined by at least one of a bag, a bladder, a bellows, a collapsible liner, a flexible container wall, and a moveable container wall to permit compression or full collapse of the compressible volume. A container may include a non-rigid liner or other substantially non-rigid element defining the compressible volume and disposed within a generally rigid housing (e.g., a housing substantially more rigid than the liner).

In one embodiment, each collapsible liner may be filled with a feed material in a zero headspace or near-zero headspace conformation to minimize or substantially eliminate any air- or gas-material interface within the liner, to as to minimize the amount of particles shed from the liner into the feed material. Each liner may be filled in a complete fashion, or, if desired, partially filled followed by headspace evacuation and sealing to permit the liner to expand or receive additional materials in the course of a mixing process. In the context of liquid materials, the presence of an air-liquid material interface in the container has been shown to increase the concentration of particles introduced into the liquid, whether during filling, transportation, or dispensation. Substantially chemically inert, impurity-free, flexible and resilient polymeric film materials, such as high density polyethylene, are preferably used to fabricate liners for use in containers according to the present invention. Desirable liner materials are processed without requiring co-extrusion or barrier layers, and without any pigments, UV inhibitors, or processing agents that may adversely affect the purity requirements for feed materials to be disposed in the liner. A listing of desirable liner materials include films comprising virgin (additive-free) polyethylene, virgin polytetrafluoroethylene (PTFE), polypropylene, polyurethane, polyvinylidene chloride, polyvinylchloride, polyacetal, polystyrene, polyacrylonitrile, polybutylene, and so on. Preferred thicknesses of such liner materials are in a range from about 5 mils (0.005 inch) to about 30 mils (0.030 inch), as for example a thickness of 20 mils (0.020 inch).

Sheets of polymeric film materials may be welded (e.g., thermally or ultrasonically) along desired portions thereof to form liners. Liners may be either two-dimensional or three dimensional in character. A liner includes at least one port or opening, preferably bounded by a more rigid material, for mating with, engaging, or otherwise disposed in flow communication with a corresponding orifice of a housing or cap thereof to enable fluid communication with the interior of the liner. Multiple ports may be provided.

A housing surrounding a liner is preferably formed of a material suitable to eliminate the passage of ultraviolet light, and to limit the passage of thermal energy, into the interior of the container. In this manner, a feed material disposed within the liner contained by the housing may be protected from environmental degradation. The housing preferably includes a gas feed passage to permit pressurization of a sealable volume between the liner and the interior surface(s) of the housing to discharge feed material from the liner. In this regard, feed material may be pressure dispensed without use of a pump contacting such material. In certain embodiments, the gas feed passage may also be selectively connectable to a vent to relieve pressure within the sealable volume as desired.

Containers including liners and housings as described hereinabove are commercially available from Advanced Technology Materials, Inc. (Danbury, Conn.) under the trade name NOWPAK®.

In one embodiment, feed materials are characterized prior to, or during, addition to multiple liner-based containers, with such characterization being useful to predict a product obtainable by mixing the contents of multiple containers. Such characterization may be quantitative and or qualitative in nature. For example, one or more weight responsive sensors or weighing elements (e.g., weight scales) may be used to determine the weight of a particular feed material provided to a liner-based container, and thereafter (i.e., during dispense and mixing operation) used to infer the mass of material present in a particulate container at a given time, with rates of material movement also being measurable using such scales if the output signals therefrom are recorded with respect to time. Flow sensing may be used during the addition of a feed material to a liner-based container to assess the total volume added to such container. Mass may be computed from total volume if density or specific gravity of the specific feed material is known. Provided that the mass of each constituent feed material is known prior to mixing, a solution having a predictable composition may be produced. In some cases, the composition, concentration, pH, density, specific gravity, or other qualitative aspect of at least one feed material may be determined prior to packaging of a feed material in a liner-based container. With respect to concentration, redox titration, spectrophotometry, refractometry, and electrochemical feedback methods may be used to effectively determine such property of feed materials such as hydrogen peroxide (which is useful as a chemical additive, reactant, or oxidizer in certain CMP solutions). Following characterization of the constituent feed materials, a conventional mass balance may then be used to account for masses of particular species in a mixture or in a mixing system.

Containers utilized with the present invention may optionally include one or more sampling ports to enable withdrawal and/or addition of material prior to use. Material may be withdrawn, for example, to verify properties and/or for quality control purposes. Material (of whatever type, including various additives, such as H₂O₂) may be added at any desired time, such as prior to, during, or after mixing/agitation.

Various methods may be applied to mix feed materials discharged from liner-based vessels. In one embodiment, a mixing apparatus comprises a reversible-flow mixing apparatus with a flow path that includes the collapsible liner of a first container and the collapsible liner of a second container. Direction of material flow to and/or from each container may be selectively controlled, from a first direction to a second direction (and vice-versa) in a fluid path. Any desirable flow directing elements may be provided to selectively control material flow for agitation and/or mixing thereof. Two or more containers in a dispensing system may be configured to operate in any desired mode of mixing, agitation, and/or dispensation.

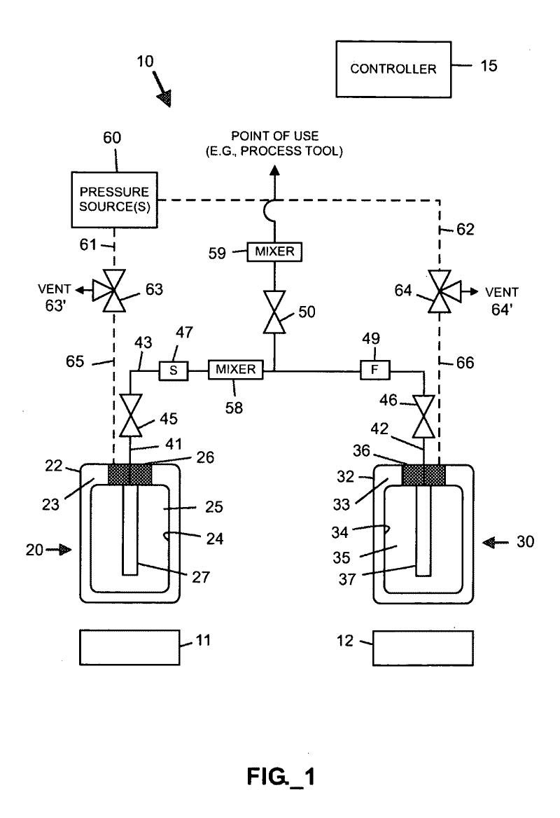

An illustration of a system employing such methodology is provided in FIG. 1. The system 10 includes a first container 20 having a first housing 22 containing a first collapsible liner 24. A first sealable volume 23 is defined between the first housing 22 and the first collapsible liner 24. The first housing 22 is preferably more rigid than the first liner 24, so that pressurization of the first sealable volume 23 is effective to compress the first collapsible liner 24 and thereby discharge or aid in discharge of any feed material contained in the liner 24 from the container 20. A first cap 26 fitted to the first container 20 includes a gas flow passage permitting fluid communication between the interior of the first collapsible liner 24 and a first discharge conduit 41. An optional first dip tube 27 coupleable to a dispensing port opening may extend from the first cap 26 into the interior of the first collapsible liner 24 to aid in dispensation. An optional first scale 11 may be positioned to sense the weight of the first container 20 or its contents, whether before and/or during mixing and dispensing operation.

The system 10 further includes a second container 30 substantially identical to the first container 20, but preferably containing a different feed material within the interior volume of the second liner 34. The second container 30 includes a second housing 32 containing a second collapsible liner 34, with a second sealable volume 33 disposed therebetween. A second cap 36 is fitted to the second container 30, and includes a gas flow passage permitting fluid communication between the interior of the second collapsible liner 34 and a second discharge conduit 42. An optional first dip tube 37 may extend from the second cap 36 into the interior of the second collapsible liner 34 to aid in dispensation. An optional second scale 12 may be further provided in sensory communication with the second container 30.

Isolation valves 45, 46 may be provided in discharge conduits 41, 42, respectively, to enable selective isolation of containers and the mixing system, such as to permit new containers to be made into a mixing system 10 upon depletion of the contents of containers 20, 30. A mixing conduit 43 extends between the isolation valves 45, 46, and disposed along a mixing conduit 43 are optional material property sensor 47, optional flow sensor 49, and an outlet valve 50, preferably in selective fluid communication with a downstream process tool. Alternatively, such mixture may be provided to a storage receptacle or other desired point of use.

At least one pressure source 60 is provided in selective fluid communication with the first sealable volume 23 of the first container 20 and with the second is sealable volume 33 of the second container 30. Disposed between the at least one pressure source 60 and the containers 20, 30 are valves 63, 64. Valve 63 is selectively operable to open a flow path between the at least one pressure source 60 and the first sealable space 23 via conduits 61, 65, and further operable to release pressure from the first sealable space 23 to a vent 63′. Likewise, valve 64 is selectively operable to open a flow path between the at least one pressure source 60 and the second is sealable space 33 via conduits 62, 66, and further operable to release pressure from the second sealable space 33 to a vent 64′. Such valves are selectively controlled. Each valve 63, 64 is preferably a three-way valve, or may be replaced with two two-way valves.

Prior to operation of the system 10, the mixing conduit 43 is preferably evacuated, such as by drawing suction on the outlet valve 50 or a vent valve (not shown) in fluid communication with the mixing conduit 43. The length and diameter of the mixing conduit 43 may be selected to provide a desired volume between the two containers 20, 30. One or more optional flow restriction elements (not shown), such as orifices or valves, may be disposed within the mixing conduit 43 to enhance mixing action as desired.

In operation of the system 10, a pressurized gas (e.g., air, nitrogen, or the like) is supplied from the at least one pressure source 60 through conduit 61, valve 63, conduit 65, and cap 26 to pressurize the first sealable space 23 and compress the first collapsible liner 24 to discharge, or aid in discharge of, a first feed material from the liner 24 through the first discharge conduit 41 and valve 45 into the mixing conduit 43. During such operation, the outlet valve 50 is positioned to disallow fluid communication with an external process tool. The second valve 46 may be open at such time to permit a flow of first feed material to enter the second collapsible liner 34 of the second container 30, with the valve 64 being opened to vent the second sealable space as the collapsible liner 34 grows in volume. After a sufficient amount of first feed material has been introduced into the mixing conduit 43 (and optionally into the second container 30), pressurized gas is supplied from the at least one pressure source 60 through conduit 62, valve 64, conduit 66, and second 36 to pressurize the second sealable space 33, thereby discharging or aiding in discharge of a second feed material from the second liner 34 through the second discharge conduit 42 and valve 46 into the mixing conduit 43. In preferred embodiments, the first and second feed materials are compositionally different from one another.

The process of sequentially pressurizing the first sealable volume 23 and the second sealable volume 33 from the at least one pressure source 60 may be reversed and/or repeated as necessary to mix substantially the entire volumes of first feed material and second feed material initially contained in the first container 20 and the second container 30 to form a mixture. Direction of fluid flow to and/or from each container through a mixing apparatus may be selectively controlled. Mixing progress may be monitored with at least one sensor 47. Such sensor(s) 47 may measure any desirable one or more characteristics of the mixture, such as a conductivity, concentration, pH, and composition. In one embodiment, the sensor 47 comprises an particle sensor, such as an optoelectrical particle size distribution sensor. In another embodiment, the sensor 47 comprises a high purity conductivity sensor. Material movement, mixing, and/or dispensation may be controlled responsive to a signal received from the sensor(s) 47. In one embodiment, the sensor 47 is used to determine the end point of a mixing process. Mixing may be sustained even after a uniform blend is obtained to maintain uniformity of the blend.

The flow sensor 49 may be similarly used to monitor mixing progress. For example, if the first feed material and the second feed material have very different viscosities, existence of a substantially constant flow rate through the mixing conduit 43 after multiple reversals of flow may indicate that mixing is near completion.

It is to be appreciated that operation of any of the various elements of the system 10 is amenable to automation, such as with a controller 15. Such controller 15 may further receive sensory input signals (e.g., from sensors 47, 49 and scales 10, 11) and take appropriate action according to pre-programmed instructions. In one embodiment, the controller comprises a microprocessor-based industrial controller or a personal computer.

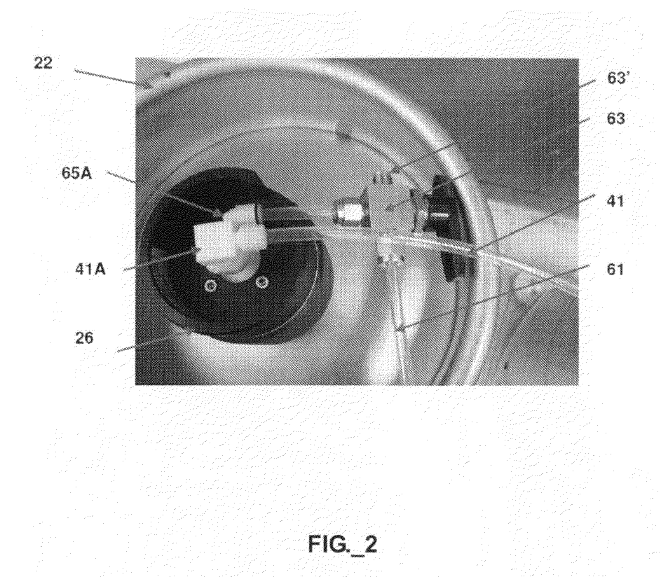

A photograph of a portion of one implementation of the system 10 is provided in FIG. 2. Shown along the top of a first container housing 22 is a cap 26 with a liquid connector 41A in fluid communication between conduit 41 and a first collapsible liner (not shown) inside the container. A gas connector 65 also coupled to the cap 26 permits fluid communication between a first sealable volume (interior to the housing 22) and valve 63, which has an associated vent 63′ and conduit 61.

In another embodiment, feed materials may be pressure dispensed from liner-based containers via flow directing elements and mixed or agitated in a mixing apparatus having a flow path that does not include one, the other, or both of the containers. In other words, materials may be moved from selected containers and mixed at a point or within a flow circuit that does not include at least one of the containers. In certain embodiments, reversible-flow and/or circulatable flow mixing apparatuses may be utilized. In cases where only a portion of each feed material is discharged into a mixing apparatus, any desirable proportion between feed materials in the mixture may be achieved for each batch. This, coupled with the ability to generate small matches only when needed, provides enhanced operational control to the end user.

To mitigate delay associated with mixing of small batches, multiple mixing apparatuses may be provided (e.g., disposed in parallel) in a single processing system. In this regard, a first mixing apparatus may be used to dispense a first mixture to a process tool while a second mixing apparatus may be used to simultaneously generate a second mixture, and vice-versa. Alternatively, a single mixing apparatus may be used in conjunction with multiple groups of containers, with material provided by a first group of containers subject to circulation or mixing in the mixing apparatus while or after mixed material provided by the second group of containers is being dispensed, and vice-versa, to provide uninterrupted delivery of mixed or agitated material to a desired point of use.

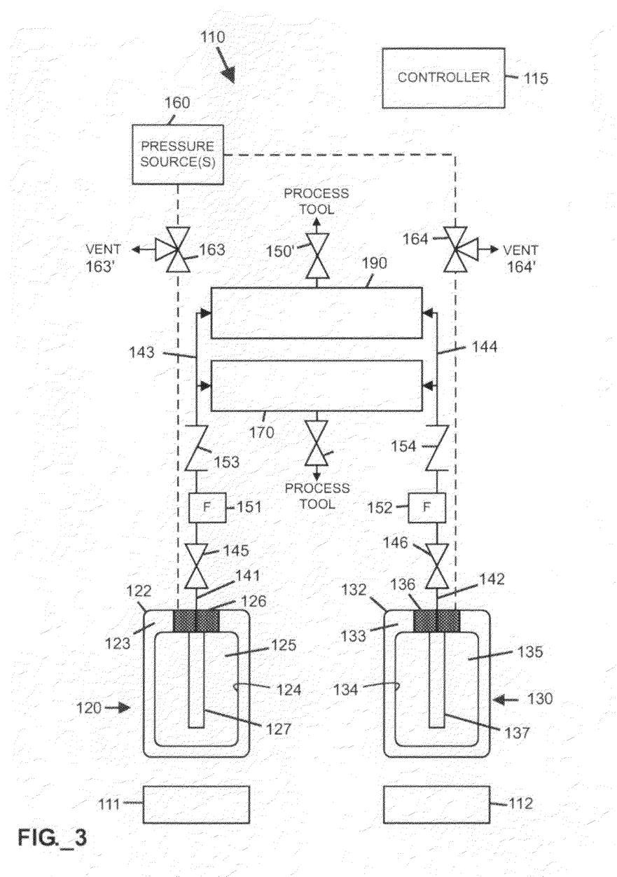

A mixing system having two parallel mixing apparatuses, each with a mixing flow path independent of the source containers, is illustrated in FIG. 3. The system 110 includes a first container 120 having a first housing 122 containing a first collapsible liner 124 and defining a first sealable space 123 therebetween. A first cap 126 includes a discharge conduit permitting discharge of a first feed material from the first collapsible liner 124, and includes a gas conduit permitting fluid communication with the first sealable space 123. Further included is a second container 130 having a second housing 132 containing a second collapsible liner 134 and defining a second sealable space 133 therebetween. A second container 136 includes a discharge conduit permitting discharge of second feed material from the second collapsible liner 134, and includes a gas conduit permitting fluid communication with the second sealable space 133. Each container 120, 130 may be positioned on a scale 111, 112.

At least one pressure source 160 is in selective fluid communication with the first sealable space 123 and the second sealable space 133 by way of ventable valves 163, 164, respectively.

Each container 120, 130 has an associated discharge conduit 141, 142 leading to an isolation valve 145, 146, a flow sensor 151, 152, and a check valve 153, 154. Parallel mixing apparatuses 170, 190, each having an associated outlet valve 150, 150′, are provided downstream of the check valves 153, 154. A controller 115 may receive any of various sensory inputs and be used to control (e.g., responsive to one or more sensory input(s)) any one or more elements of the system 110.

In operation of the system 110, pressure from the at least one pressure 160 is applied to discharge at least a portion of a first feed material from the first container 120 into one of the mixing apparatuses 170, 190, and is further applied to discharge at least a portion of a second feed material from the second container 130 into one of the mixing apparatuses 170, 190. Such mixing apparatuses 170, 190 are preferably adapted to not only mix the feed materials to form a mixture, but also maintain such mixture in a desired mixed or suspended state. Flow sensors 151, 152 may be used to determine the quantity of material supplied from each container 120, 130. Check valves 153, 154 prevent backflow of the first and second feed material and/or any mixture thereof into the first container 120 and the second container 130.

Once the feed materials are supplied to one of the mixing apparatuses 170, 190, mixing may proceed in any desired manner. Reversible flow and/or circulatable flow of the feed materials in combination through such mixing apparatuses 170, 190 may be employed. Any desired fluid motive means may be used, such as pumps, gravity, vacuum, and/or controlled application of external force. At least one of a piston/cylinder and a variable-volume chamber in at least selective fluid communication with the fluid path.

In one embodiment, pressure dispensation with direct contact between a working fluid (e.g., compressed gas) and feed materials may be employed. In another embodiment, direct contact between the feed materials and any working fluid (e.g., pressurized air or nitrogen) may be minimized through use of an interposing liner, such as may be useful in certain applications to avoid possible contamination. In one embodiment, a mixing apparatus comprises a least one peristaltic pump. In another embodiment, a mixing apparatus comprises at least one compressible bladder and at least one compression element adapted to selectively compress the bladder to effect material movement. Such compressible bladder may be embodied in a collapsible liner disposed within a housing more rigid than the liner. In other words, a mixing element may include at least one liner-based container adapted for pressure dispensation as described hereinabove. The variable volume nature of such containers permits feed materials to be controllably moved from one point to another without fear of contamination by environmental contact. In one embodiment, a mixing apparatus includes multiple compressible bladders each having an associated compression element (of any suitable type, including but not limited to at least one pressure source), and such bladders may optionally be in at least intermittent fluid communication with each other.

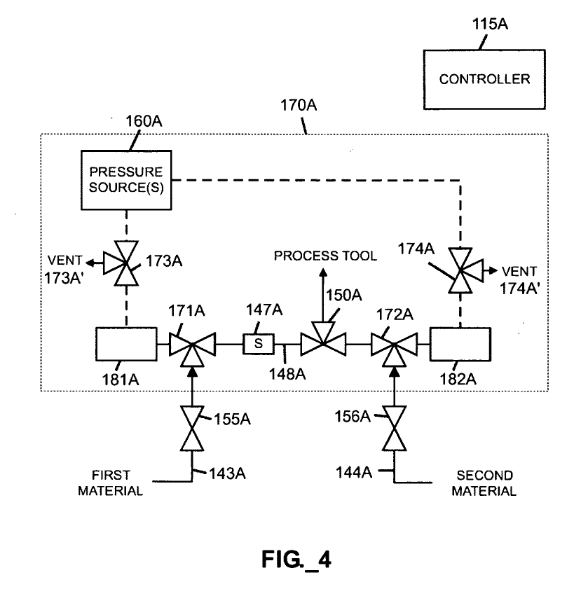

FIG. 4 illustrates a reversible-flow mixing apparatus 170A useable as a component (e.g., substituted for either mixing apparatus 170, 190) of the mixing system 110 of FIG. 3. The mixing apparatus 170A includes at least one pressure source 160A in selective fluid communication with mixing elements 181A, 182A through ventable valves 173A, 174A each having an associated vent 173A′, 174A′. As indicated previously, each mixing element may comprise a peristaltic pump, a compressible bladder/compression element combination, or a liner-based container adapted for pressure dispensation as described hereinabove.

First and second feed materials may be supplied to the mixing apparatus 170A by way of supply conduits 143A, 144A and isolation valves 155A, 156A into receiver valves 171A, 172A disposed in a mixing conduit 148A. A sensor 147A as described hereinabove may be provided in the mixing conduit 148A, and may be used to assess when mixing is complete. Mixing proceeds by alternately activating the first and second mixing elements 181A, 182A to force the first and second components back and forth within the mixing conduit 148A to form a mixture. Such mixture may be discharged through an outlet valve 150A to a desired point of use, e.g., a process tool or a storage receptacle. A controller 115A, which may be the same as or different from the controller 115 illustrated in FIG. 3, may be provided to receive sensory inputs and control any of the various elements of the mixing apparatus 170A responsive to such sensory input(s).

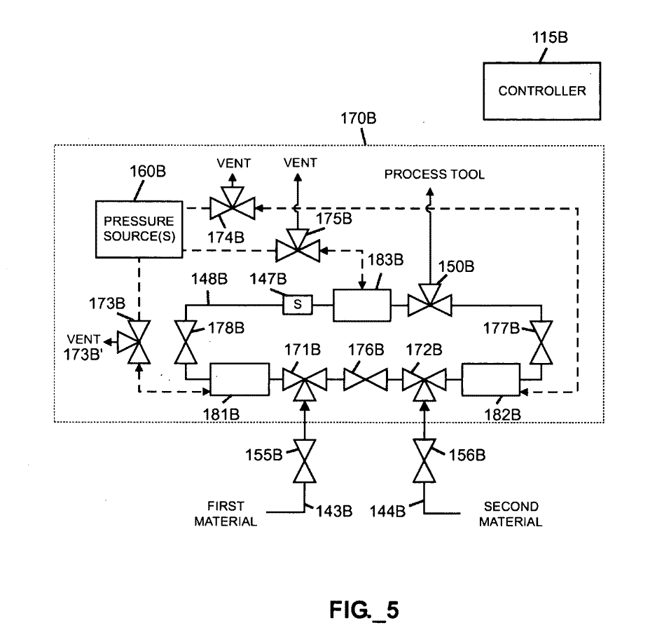

FIG. 5 illustrates a circulatable flow mixing apparatus 170B that may alternatively be used as a component (e.g., substituted for either mixing apparatus 170, 190) of the mixing system 110 of FIG. 3. Preferably, a circulatable flow mixing apparatus include a plurality of isolatable segments and permits materials disposed therein to be sequentially moved from one segment to another, with flow patterns including unidirectional flow (e.g., with a circulation loop) and/or reversible flow. Direction of fluid flow may be selectively controlled. The mixing apparatus 170B includes at least one pressure source 160B in selective fluid communication with mixing elements 181B, 182B, 182C through ventable valves 173B, 174B, 175B each having an associated vent. As indicated previously, each mixing element may comprise a peristaltic pump, a compressible bladder/compression element combination, or a liner-based container adapted for pressure dispensation as described hereinabove. Other types of mixing elements may be used.

First and second feed materials may be supplied to the mixing apparatus 170B by way of supply conduits 143B, 144B and isolation valves 155B, 156B into receiver valves 171B, 172B disposed in a mixing conduit 148B. At least one sensor 147B as described hereinabove may be provided in the mixing conduit 148B, and may be used to assess when mixing is complete. Valves 176B, 177B, 178B are further provided to selectively partition the mixing conduit 148B. Mixing proceeds by sequentially activating the first, second, and third mixing elements 181B, 182B, 183B within temporarily isolated partitions of the mixing conduit 148B to force the first and second components together around the loop and form a mixture. One or more flow restriction elements or mixing enhancing elements (e.g., static mixers, textured interior walls, or the like) may be provided to enhance mixing action within the mixing conduit 148B. The resulting mixture may be discharged through an outlet valve 150B to a desired point of use, e.g., a process tool or a storage receptacle. A controller 115B, which may be the same as or different from the controller 115 illustrated in FIG. 3, may be provided to receive sensory inputs and control any of the various elements of the mixing apparatus 170B.

In one embodiment, two containers sizes may be used for agitation of materials initially stored in at least one of the containers. Such containers may or may not be equally sized. Optionally, material may be initially disposed in a first the container in a zero headspace conformation. Material may be moved back and forth between containers, or within a flow path not necessarily including one or more containers, for as many cycles (e.g. a user-defined threshold number of cycles) and/or under such conditions as necessary to achieve a blend or mixture of desired consistency or uniformity. Sensory feedback may be used to verify attainment of a desired condition. Alternatively, material may be moved or circulated for a predetermined number of cycles. Following attainment of the desired condition, material may be maintained within one or more of the two containers or discharged to a desired point of use, such as a process tool, storage receptacle, or the like.

In another embodiment, a first container and second container each initially contain different first and second materials, and a third container is provided to serve as a volume for mixing at least a portion of the materials initially contained in the first and second containers. Two or more of the first, second, and third containers may or may not be equally sized. Optionally, the first material and/or second material may be initially disposed in respective the first container and/or second container in a zero headspace conformation. Material may be moved back and forth between at least two of the three containers, or within a flow path not necessarily including one or more of the three containers, for as many cycles and/or under such conditions as necessary to achieve a mixture of desired consistency or uniformity.

In another embodiment, multiple redundant sets (e.g., pairs, trios, etc.) each including multiple containers (e.g., first container, second container, optional third container, etc.) may be provided to provide uninterrupted delivery of mixed and/or agitated materials, to as to permit a process tool utilizing materials supplied by such containers to be operated on a substantially continuous basis without shutdown. For example, a first container pair including a first container and a second container may be used to agitate or mix at least two materials, and subsequently dispense same to a material-utilizing process tool. As material sourced by the first material pair is dispensed to the process tool, similar (or different, if desired) materials may be mixed or agitated in a second container pair including a first container and a second container. Upon exhaustion of mixed or agitated material supplied by the first container pair, mixed or agitated material may be supplied to the process tool from the second container pair. During dispensation of material from the second container pair, material in the first container pair may also be replenished, and vice-versa.

It is to be appreciated that the foregoing systems and apparatuses as described hereinabove are applicable to various novel mixing methods.

In one embodiment, a method for blending feed materials involves establishing any of mass, weight, density, specific gravity, concentration, pH, and volume of a first material and second material to be supplied to a first compressible volume and second compressible volume, respectively. Such volumes are compressed to discharge at least a portion of the first and second materials to flow into a mixing apparatus. Flow through the mixing apparatus forms a mixture, which may be dispensed to a desired point of use.

In another embodiment, a method for blending feed materials utilizes first and second containers each defining compressible volumes therein. At least a first feed material (e.g., a first and a second feed material) is supplied from at least one compressible volume and flowed through a mixing apparatus. Such mixing apparatus may include, for example, a reversible-flow or circulating flow mixing apparatus.

In another embodiment, a method for supplying blended material utilizes a first plurality of containers and a second plurality of containers with each container including a compressible volume adapted for selective discharge of at least one feed material. At least one mixing apparatus is in selective fluid communication with the first plurality of containers and the second plurality of containers. At least one feed material obtained from the first plurality of containers is blended utilizing the at least one mixing apparatus, and at least one feed material obtained from the second plurality of containers is blended utilizing the at least one mixing apparatus. The at least one feed material obtained from the first plurality of containers may be compositionally different from, or the same as, the at least one feed material obtained from the second plurality of containers. The at least one mixing apparatus may include a single mixing apparatus, or multiple mixing apparatuses. Blended feed material from the first plurality of containers is supplied to a desired point of use, and blended feed material from the second plurality of containers is supplied to a desired point of use. Blending of feed material obtained from one group of containers may proceed while feed material obtained from another group of containers is dispenses, and vice-versa. In this manner, feed material may be supplied on a substantially continuous basis for a desired point of use, such as a semiconductor process tool.

In another embodiment, blended feed material is generated by supplying a second feed material to an interior liner of first container that initially contains (e.g., is partially filled with) a first feed material. Such liner is preferably collapsible and formed of a flexible film material, and disposed within a housing that is substantially more rigid than the liner to define a sealable volume therebetween. The first volume may be pressurized (e.g., with a source of pressurization gas, connected to the sealable volume via a gas feed passage) to promote discharge at least a portion of the first material and at least a portion of the second material from the first liner and to promote mixing between the discharged first material and the discharged second material. Such mixing may utilize a mixing apparatus as described hereinabove in at least intermittent communication with the liner. Such mixing apparatus may include a second container, which may include a compressible volume that may be defined by a collapsible liner. Upon substantial completion of mixing, a mixture or blend including the discharged first feed material and discharged second feed material may be returned to the first liner for dispensing the mixture therefrom. In one embodiment, the first and second materials are chemically interactive (e.g., reactive) with one another. In such context, the foregoing method promotes blending near a point of ultimate use, such as may be useful to minimize potential degradation of a mixture. For example, the second feed material may include an oxidizing agent or other additive for use in a slurry useful for performing a CMP process. Premature addition of the oxidizing agent or other additive (e.g., prior to shipment of a first feed material from a chemical supplier to a semiconductor processing facility) may reduce the oxidizing (or other reaction) potential and therefore efficacy of the resulting CMP slurry.

A feed material supply system adapted to enable the foregoing method is disclosed in connection with FIG. 1 described previously herein. Such a system generally includes at least one liner-based container arranged for pressure dispensing of feed material therefrom. Such liner may initially contain a first feed material. It may be desirable to blend a second material (that is compositionally different from the first material) to the first material just prior to use of the blend (e.g., supply of the blended material to an industrial process) to minimize possible degradation of the first and second materials in contact with one another. Accordingly, a feed material supply apparatus arranged to supply a second feed material to contact said first feed material in the collapsible liner. Such feed material supply apparatus may include another liner-based container as described hereinabove. Alternatively, a feed material supply apparatus may include a conventional reservoir and/or pumped material supply system, such as bulk supply systems for chemicals such as peroxide, ammonium hydroxide, acids, or bases that may already reside in a typical semiconductor processing facility. Additionally provided is at least one metering apparatus and/or sensor (e.g., mass flowmeter, other flowmeter, flow sensor, scale, or the like) adapted to generate an output signal correlative of an amount of second feed material supplied by the feed material supply apparatus to contact said first feed material in the collapsible liner. The first container is operatively coupled to supply said first feed material and said second feed material to a downstream point of use, such as a process tool adapted for semiconductor processing. A mixing apparatus is preferably further provided to mix the first and second feed materials. The foregoing system desirably enables material blending near a point of ultimate use, as the first container may simultaneously include (e.g., intermittently operable) connections to an upstream feed material source and to a downstream process tool.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

### INDUSTRIAL APPLICABILITY

The present invention is useful in industry, including blending and distribution of ultra pure materials as feedstocks for various industrial processes, including semiconductor processing.

1. A system for blending feed materials, comprising:
a first container defining a first compressible volume and adapted for selective discharge of a first feed material from the first compressible volume;
a second container defining a second compressible volume and adapted for selective discharge of a second feed material from the second compressible volume;
a mixing apparatus in at least intermittent fluid communication with the first compressible volume and the second compressible volume, said mixing apparatus being adapted to mix at least a portion of a first feed material from the first container with at least a portion of a second feed material from the second container to form a mixture; and
a dispensing port adapted to dispense the mixture to a desired point of use.

2. A system for blending or agitating feed materials, comprising:
a first container defining a first compressible volume and adapted for selective discharge of a first feed material from the first compressible volume;
a second container defining a second compressible volume, the second container being adapted for selective receipt of at least a portion of the first feed material, and for selective subsequent discharge of said at least a portion of the first feed material;
a flow directing element adapted to selectively direct at least a portion of the first feed material through a fluid flow path including the first container and the second container to agitate said first feed material; and
a dispensing port adapted to dispense the agitated first feed material to a desired point of use.

3. The system of claim 1, wherein at least one of the first compressible volume and the second compressible volume is bounded by any of a bag, a bladder, and a bellows.

4. The system of claim 1, wherein each of the first container and the second container comprises a flexible container wall permitting compression of the first compressible volume and the second compressible volume, respectively.

5. The system of claim 1, wherein any of the first compressible volume and the second compressible volume is bounded by a moveable container wall.

6. The system of claim 1, wherein any of the first compressible volume and the second compressible volume is bounded by a collapsible liner disposed within a housing that is substantially more rigid than the collapsible liner.

7. The system of claim 1, wherein said mixing apparatus is adapted for reversible flow of the first material and second material in combination between the first container and the second container.

8. The system of claim 1, wherein said mixing apparatus includes a circulation loop in at least intermittent fluid communication with the first compressible volume and the second compressible volume.

9. The system of claim 1, further comprising at least one sensor adapted to sense of any of particle count, particle size distribution, conductivity, concentration, pH, and composition of the mixture.

10. The system of claim 1, wherein said mixing apparatus comprises at least one of a piston/cylinder and a variable-volume chamber.

11. A method for blending or agitating feed materials utilizing (A) a first container defining a first compressible volume and adapted for discharge of at least one feed material from the first compressible volume, and (B) a second container defining a second compressible volume and adapted for discharge of at least one feed material from the second compressible volume, the method comprising at least one of steps (i) and (ii):
(i) supplying a first feed material from the first compressible volume and supplying a second feed material from the second compressible volume to a mixing apparatus, and flowing the first feed material and the second feed material through the mixing apparatus to yield a blended feed material or mixture; and
(ii) supplying at least a portion of a first feed material from either the first compressible volume or the second compressible volume to a flow directing element adapted to selectively direct at least a portion of the first feed material through a fluid flow path including the first container and the second container to yield an agitated first feed material.

12. The method of claim 11, comprising (i) supplying a first feed material from the first compressible volume and supplying a second feed material from the second compressible volume to a mixing apparatus, and flowing the first feed material and the second feed material through the mixing apparatus to yield a blended feed material or mixture.

13. The method of claim 11, comprising (ii) supplying at least a portion of a first feed material from either the first compressible volume or the second compressible volume to a flow directing element adapted to selectively direct at least a portion of the first feed material through a fluid flow path including the first container and the second container to yield an agitated first feed material.

14. The method of claim 11, wherein the first container defines a first compressible volume and is adapted for selective discharge of a first feed material from the first compressible volume, the second container defines a second compressible volume and is adapted for selective discharge of a second feed material from the second compressible volume, the method further comprising:
compressing the first compressible volume to discharge at least a portion of the first feed material; and
compressing the second compressible volume to discharge at least a portion of the second feed material.

15. The method of claim 14, wherein:
the first container comprises (i) a first collapsible liner defining the first compressible volume, the first collapsible liner comprising a flexible film material and defining a first port, (ii) a first housing adapted to contain the first collapsible liner, said housing defining at least a first orifice adapted to communicate with the first port, wherein the first housing and the first liner define a sealable first volume therebetween, and wherein the first housing is more rigid than the first liner; and (iii) a first gas feed passage coupleable to said at least one pressure source adapted to pressurize the first volume during discharge operation;
the second container comprises (i) a second collapsible liner defining the second compressible volume, the second collapsible liner comprising a flexible film material and defining a second port, (ii) a second housing adapted to contain the second collapsible liner, said housing defining at least a second orifice adapted to communicate with the second port, wherein the second housing and the second liner define a sealable second volume therebetween, and wherein the second housing is more rigid than the second liner; and (iii) a second gas feed passage coupleable to said at least one pressure source to pressurize the second volume during discharge operation;
said compressing of the first compressible volume comprises pressurizing the sealable first volume; and
said compressing of the second compressible volume comprises pressurizing the sealable second volume.

16. The method of claim 14, further comprising
utilizing a sensor in sensory communication with a fluid path to generate a signal indicative of any of particle count, particle size distribution, conductivity, concentration, pH, and composition of feed material within the fluid path; and
controlling at least one of the following responsive to the signal: (i) flow through the mixing apparatus, (ii) flow through the flow directing element, (iii) dispensing of the blended feed material or mixture, and (iv) dispensing of the agitated first feed material.

17. A feed material supply system comprising:
a first container adapted for pressurized or pressure-assisted discharge of a first feed material, the first container comprising (i) a collapsible liner comprising a flexible film material, defining a port, and initially containing said first feed material, (ii) a housing adapted to contain the collapsible liner, said housing defining at least one orifice adapted to communicate with the port, wherein the housing and the liner define a sealable first volume therebetween, and wherein the housing is more rigid than the liner; and (iii) a gas feed passage coupleable to at least one pressure source adapted to selectively pressurize the first volume;
a feed material supply apparatus operatively coupled to supply a second feed material to contact said first feed material in the collapsible liner, wherein the second feed material is compositionally different from the first feed material; and
at least one metering apparatus or sensor adapted to generate an output signal correlative of an amount of second feed material supplied by the feed material supply apparatus to contact said first feed material in the collapsible liner;
wherein said first container is operatively coupled to supply said first feed material and said second feed material to a downstream process tool.
